(19) United States
(12) Patent Application Publication
(10) Pub. No.: US 2025/0001886 A1
(43) Pub. Date: Jan. 2, 2025

(54) AUTOMATIC CHARGING SYSTEM

(71) Applicant: TOYOTA JIDOSHA KABUSHIKI KAISHA, Toyota-shi Aichi-ken (JP)

(72) Inventors: Masaaki SATO, Susono-shi Shizuoka-ken (JP); Takeru SHIRASAWA, Sunto-gun Shizuoka-ken (JP); Yusuke SAITO, Gotenba-shi Shizuoka-ken (JP); Teruaki HAIBARA, Ashigarakami-gun Kanagawa-ken (JP)

(73) Assignee: TOYOTA JIDOSHA KABUSHIKI KAISHA, Toyota-shi Aichi-ken (JP)

(21) Appl. No.: 18/758,847

(22) Filed: Jun. 28, 2024

(30) Foreign Application Priority Data
Jun. 30, 2023 (JP) 2023-108746

(51) Int. Cl. B60L 53/35; E05B 77/48

(52) U.S. Cl. CPC B60L 53/35; E05B 77/48

(57) ABSTRACT

An automatic charging system includes: a vehicle driven by power from a power storage device; a charger equipped with a charging cable having a charging connector; a charging robot equipped with a robot arm, which automatically grasp the charging connector, and insert and remove the charging connector into and from a charging port of the vehicle, so that power is charged to the power storage device; and a control device which causes the vehicle to lock a door and a window, each of which is a closest to the charging port, during at least a charging operation, in which the charging robot receives an instruction to start automatic charging, starts autonomous moving from a predetermined stand-by position, completes charging power to the power storage device, and returns to the predetermined stand-by position.

### CROSS-REFERENCE TO RELATED APPLICATION(S)

The present application claims priority to and incorporates by reference the entire contents of Japanese Patent Application No. 2023-108746 filed in Japan on Jun. 30, 2023.

### BACKGROUND

The present disclosure relates to an automatic charging system.

Japanese Laid-open Patent Publication No. 2021-032721 discloses a technique in which the power supply robot holds the power supply connector of the power supply facility, moves to the vehicle parked in the parking space, and, by connecting the power supply connection to the inlet provided in the vehicle, the power supply facility supplies power to the battery of the vehicle.

### SUMMARY

There is a need for providing an automatic charging system capable of suppressing contact between an occupant of a vehicle and a charging robot during charging work by the charging robot.

According to an embodiment, an automatic charging system includes: a vehicle driven by power supplied from a power storage device; a charger equipped with a charging cable having a charging connector; a charging robot, which is autonomously movable, equipped with a robot arm, the robot arm being configured to automatically grasp the charging connector, and insert and remove the charging connector into and from a charging port of the vehicle parked in a parking space, so that the charging connector is inserted into the charging port and power is supplied from the charger and is charged to the power storage device; and a control device configured to cause the vehicle to lock a door and a window, each of which is a closest to the charging port, during at least a charging operation, in which the charging robot receives an instruction to start automatic charging, starts autonomous moving from a predetermined stand-by position, completes charging power to the power storage device, and returns to the predetermined stand-by position.

According to an embodiment, an automatic charging system includes: a vehicle driven by power supplied from a power storage device; a charger equipped with a charging cable having a charging connector; a charging robot, which is autonomously movable, equipped with a robot arm, the robot arm being configured to automatically grasp the charging connector, and insert and remove the charging connector into and from a charging port of the vehicle parked in a parking space, so that the charging connector is inserted into the charging port and power is supplied from the charger and is charged to the power storage device; and a control device configured to cause the vehicle to lock all doors and all windows, which are on a side of the charging port of the vehicle, during at least a charging operation, in which the charging robot receives an instruction to start automatic charging, starts autonomous moving from a predetermined stand-by position, completes charging power to the power storage device, and returns to the predetermined stand-by position.

### BRIEF DESCRIPTION OF THE DRAWINGS

FIG. 1 is a diagram illustrating a charging system of a parking lot according to a first embodiment;

FIG. 2 is a diagram showing a configuration of an automatic charging system according to the first embodiment;

FIG. 3 is a flowchart illustrating an example of an automatic charging control according to the first embodiment;

FIG. 4 is a flowchart illustrating an example of an automatic charging control according to the second embodiment;

FIG. 5 is a diagram illustrating a parking lot applying the automatic charging system according to the third embodiment;

FIG. 6 is a flowchart illustrating an example of the automatic charging control according to the third embodiment;

FIG. 7 is a diagram illustrating a parking lot applying the automatic charging system according to the fourth embodiment; and

FIG. 8 is a flowchart illustrating an example of the automatic charging control according to the fourth embodiment.

### DETAILED DESCRIPTION

In the technique disclosed in Japanese Laid-open Patent Publication No. 2021-032721, during charging work by the charging robot, the occupant gets out from the door of the vehicle, or when the occupant comes out a hand or the like from the window of the vehicle, there is a risk of contact between the vehicle occupant and the charging robot.

### First Embodiment

Hereinafter, a first embodiment of the automatic charging system according to the present disclosure is disclosed. Note that the present disclosure is not limited by any of the embodiments described therein.

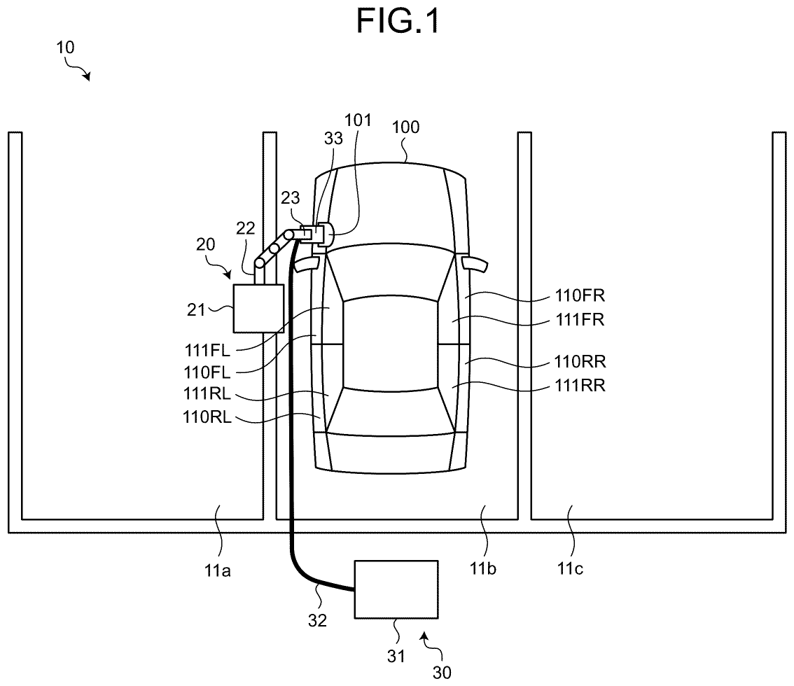

FIG. 1 is a diagram illustrating a parking lot 10 to which the automatic charging system 1 according to a first embodiment. Herein, FIG. 1 is a view of the parking lot 10 from above. FIG. 1 is a diagram illustrating a schematic configuration of an automatic charging system 1 in the first embodiment.

FIG. 1 illustrates three parking space 11a, 11b, and 11c of a plurality of parking spaces provided in the parking lot 10 in a parking facility, the parking space 11a, 11b, and 11c are used as the charging spaces. Three parking space 11a, 11b, and 11c are arranged side by side in the lateral direction of the parking spaces 11a, 11b, and 11c (vehicle lateral direction). In the following explanation, when not particularly distinguished parking space 11a, 11b, and 11c, simply it is referred to as parking space 11.

In FIG. 1, the vehicle 100 to be charged is parked in the parking space 11b. The Vehicle 100 includes a charging port 101, front and rear and left and right door 110FL, 110FR, 110RL, and 110RR and front and rear and left and right window 111FL, 111FR, 111RL, and 111RR and the like. A charging port 101 is provided on the vehicle front side than the front left side of the door 110FL on the vehicle 100. The front and rear left and right door 110FL, 110FR, 110RL, and 110RR are provided to be opened and closed through a hinge with respect to the vehicle body. Front and rear left and right windows 111FL, 111FR, 111RL, and 111RR are provided to be opened and closed in front and rear left and right door 110FL, 110FR, 110RL, and 110RR, respectively. Further, in the front and rear left and right door 110FL, 110FR, 110RL, and 110RR, the lock mechanism provided corresponding to each, by controlling such as by a vehicle control device provided in the vehicle 100, and the lock and unlock can be individually. Further, the front and rear left and right windows 111FL, 111FR, 111RL, and 111RR, by controlling the lock mechanism provided corresponding to each by a vehicle controller or the like, can be locked and unlocked individually.

In the vicinity of the parking spaces 11a, 11b, and 11c, a charging robot 20 and the charger 30 is provided to be used for charging the vehicle 100 parked in the parking spaces 11a, 11b, and 11c. In the automatic charging system 1 according to the first embodiment, the automatic charging device 2 is constituted by the charging robot 20 and the charger 30. The charging robot 20 and the charger 30 is configured to communicate with each other.

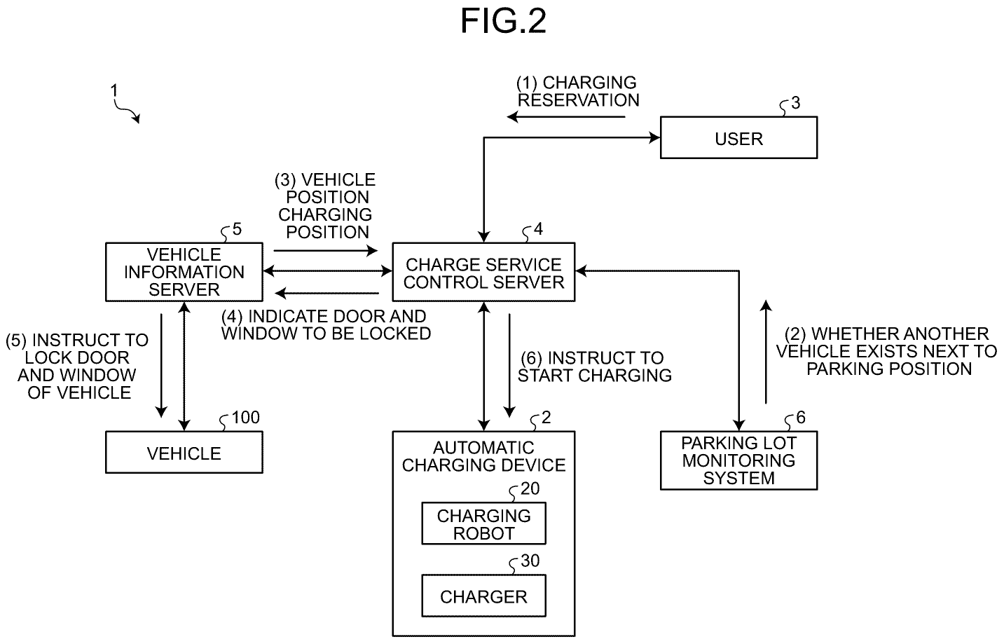

In the automatic charging system 1 according to the first embodiment, the automatic charging by the automatic charging device 2 for the vehicle 100 parked in the parking space 11 of the parking lot 10, a charging service control server 4 is implemented by managing. The charging service control server 4 is provided with a control device for performing at least various controls related to automatic charging as illustrated in (1) to (6) in FIG. 2.

The charging service control server 4 is communicatively configured with the communication terminal owned by the user 3 of the vehicle 100 parked in the parking space 11 of the parking lot 10. The charging service control server 4 is capable of receiving various information such as charging reservation for the vehicle 100 transmitted from the communication terminal of the user 3 (in FIG. 2 (1)).

Further, the charging service control server 4 is communicably configured with the parking lot monitoring system 6 for monitoring the parking lot 10. The charging service control server 4, based on the detection result of the vehicle detecting device constituted by the imaging device and various sensors having the parking lot monitoring system 6, is capable of checking the presence or absence of the vehicle 100 in the parking space 11a, 11b, and 11c (parking state) (in FIG. 2 (2)).

Further, the charging service control server 4 is configured to communicate with the vehicle 100 through the vehicle information server 5 and is capable of communicating with the vehicle 100 parked in the parking space 11. The charging service control server 4, is capable of receiving various information items such as an SOC (State Of Charge of the battery is a power storage device mounted on the vehicle 100) and information about such required power, and such as vehicle information about the position of the charging port 101 of the vehicle 100, via the vehicle information server 5 from the vehicle 100 (3 in FIG. 2). Further, the charging service control server 4 can transmit information items such as an instruction signal for freely opening and closing the unlocking and charging lid of the charging port 101 of the vehicle 100, to the vehicle 100 via the vehicle information server 5. Further, the charge service control server 4 is capable of transmitting information items such as instruction signals to open and close the front and rear and left and right door 110FL, 110FR, 110RL, and 110RR of the vehicle 100, and the front and rear and left and right window 111FL, 111FR, 111RL, and 111RR of the vehicle 100, via the vehicle information server 5 ((4) and (5) in FIG. 2).

Further, the charging service control server 4 is capable of communicating with the automatic charging device 2 provided in the parking lot 10 (charging robot 20 and charger 30). The charging service control server 4 is capable of transmitting various information such as vehicle information about the position of the charging port 101 of the information and the vehicle 100 about the amount of charging power of the battery mounted on the vehicle 100, to the automatic charging device 2 (charging robot 20 and charger 30). Further, the charging service control server 4 is capable of transmitting signals instructing charging start on the basis of the charging reservation from the user 3 (charging robot 20 and the charger 30) to the automatic charging device 2 (in FIG. 2 (6)).

The charging robot 20 includes a robot body 21, which is a moving body autonomously movable (autonomously travelable), a robot arm 22 having a base end portion connected to the robot body 21, the robot hand 23 provided at the distal end of the robot arm 22.

The charger 30 is constituted by a charger body 31 and the charging cable 32 and the charging connector 33. Further, as illustrated in FIG. 1, the charger body 31 is fixed to the ground.

In the charging system of the parking lot 10 according to the first embodiment, the charger 30 is arranged to correspond to the three parking spaces 11a, 11b, and 11c. In the state in FIG. 1, it is capable of charging using a charger 30 to the vehicle 100 parked in the parking space 11b.

For example, when automatic charging to the vehicle 100 parked in the parking space 11b is performed, the robot body 21 of the charging robot 20 autonomously moves to a position to grasp the charging connector 33 of the charger 30 by extending the robot arm 22 of the charging robot 20. The charging robot 20 recognizes the charging connector 33 by a camera which is an imaging device provided on the robot arm 22, and grasps the charging connector 33 by the robot hand 23. Thereafter, in the charging robot 20, the robot body 21 autonomously moves to a position where the charging connector 33 can be inserted into the charging port 101 of the vehicle 100. Then, the charging robot 20 recognizes the charging port 101 of the vehicle 100 by the camera provided on the robot arm 22, to extend the robot arm 22 to insert the charging connector 33 to the charging port 101 of the vehicle 100. When the charging connector 33 is inserted to the charging port 101 of the vehicle 100, the charger 30 supplies power to the vehicle 100 via the charging cable 32 and the charging connector 33 from the power supply device provided in the charger body 31 to charge the battery, which is a power storage device provided in the vehicle 100. Further, the charging robot 20, after inserting the charging connector 33 to the charging port 101 of the vehicle 100, releases the robot hand 23 from the charging connector 33, to return the robot arm 22 back to the preset arm reference position.

Upon completion of charging of the vehicle 100, the robot body 21 of the charging robot 20 autonomously moves to a position where the robot arm 22 is extended to grasp the charging connector 33 inserted into the vehicle 100 by the robot hand 23. The charging robot 20 then grasps the charging connector 33 by the robot hand 23 and withdraws the charging connector 33 from the vehicle 100. Thereafter, in order to return the charging connector 33 to the plug reference position preset in the charger 30, the robot body 21 of the charging robot 20 is moved to the charger 30 side. Then, the charging robot 20 extends the robot arm 22 to return the charging connector 33 to the plug reference position.

Thus, for each vehicle 100 parked in the parking spaces 11a, 11b, and 11c of the parking lot 10, it is possible to automatically charge by the automatic charging device 2 (charging robot 20 and charger 30).

In the automatic charging system 1 according to the first embodiment, the charging service control server 4, in accordance with the work contents of the automatic charging by the charging robot 20, controls the opening and closing of the door 110 and window 111 with respect to the vehicle 100 to be charged. Specifically, in the automatic charging system 1 according to the first embodiment, when the charging service control server 4 receives the charging reservation from the user 3, control is performed to lock the closest door 110FL and window 111FL to the charging port 101 in the vehicle 100 to be charged. Then, in the automatic charging system 1 according to the first embodiment, after locking the closest door 110FL and window 111FL to the charging port 101, the charging operation starts with the charging robot 20.

In the automatic charging system 1 according to the first embodiment, at the time of insertion and removal of the charging connector 33 by the charging robot 20, by locking the closest door 110FL to the charging port 101 of the vehicle 100, the occupant in the vehicle to suppress getting off the door 110FL, and it is possible to reduce the risk of contact between the vehicle 100 occupant and the charging robot 20 (robot arm 22). Further, in the automatic charging system 1 according to the first embodiment, by locking the opening operation of the window 111FL closest to the charging port 101 of the vehicle 100, it is possible to suppress contacting between an occupant in the vehicle to extend the hand from the window 111FL with the charging robot 20 (robot arm 22).

Further, in the automatic charging system 1 according to the first embodiment, the charging robot 20 is provided with a contact detection sensor for detecting that the occupant or the like is in contact with the charging robot 20. Then, during the charging operation by the charging robot 20 performs control to constantly monitor the presence or absence of contact with respect to the charging robot 20. Then, if the contact with the charging robot 20 is detected, the autonomous running by the robot body 21, the operation of the robot arm 22, the power supply from the charger 30, or the charging operation is stopped. Thereafter, when the contact with the charging robot 20 is no longer detected, for example, the charging operation is resumed after a lapse of a predetermined time.

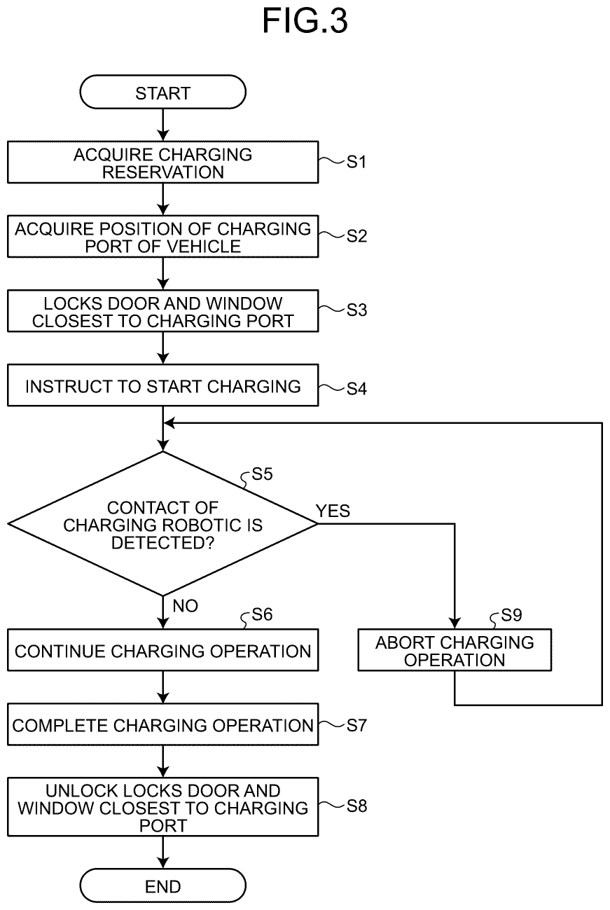

FIG. 3 is a flowchart illustrating an example of an automatic charging control according to the first embodiment.

First, in step S1, the charging service control server 4 acquires the charging reservation from the user 3. Next, in step S2, the charging service control server 4 acquires the position of the charging port 101 of the vehicle 100 to be charged from the vehicle information server 5. Next, in step S3, the charging service control server 4 locks the door 110FL and the window 111FL closest to the charging port 101 in the vehicle 100 to the vehicle 100 through the vehicle information server 5. Next, in step S4, the charging service control server 4 instructs the automatic charging device 2 to start charging.

Next, in step S5, it is determined whether or not the contact of the charging robotic device 20 is detected. If it is determined that the contact of the charging robot 20 is detected (Yes in step S5), the process proceeds to the step S9. In step S9, the charging operation by the charging robot 20 is aborted. Thereafter, the process proceeds to step S5.

On the other hand, in step S5, if it is not detected the contact of the charging robot 20 (No in step S5), the process proceeds to step S6. In step S6, the charging operation is continuously performed by the charging robot 20. Next, in the step S7, when the electric power is supplied to the battery of the vehicle 100 and the charging is completed, the charging operation by the charging robot 20 is ended. Next, in step S8, the charging service control server 4 unlocks the door 110FL and the window 111FL closest to the charging port 101 of the vehicle 100 to the vehicle 100 through the vehicle information server 5. Thereafter, the charging service control server 4 ends a series of automatic charging control.

In the automatic charging system 1 according to the first embodiment, when performing the charging operation by the charging robot 20, it performs control to lock only the closest door 110FL and window 111FL to the charging port 101 of the vehicle 100. Thus, in the automatic charging system 1 according to the first embodiment, during the charging operation in which the charging robot 20 is closest to the charging port 101, it is possible to prevent the occupant getting on and off by opening the door 110FL close to the charging port 101. In addition, it is possible to prevent an occupant in the vehicle from releasing the hand or the like outside the vehicle by opening the window 111FL close to the charging port 101. Thus, in the automatic charging system 1 according to the first embodiment, during the charging operation by the charging robot 20, it is possible to suppress the contact between the charging robot 20 and the charging cable 32 with the occupant and the door 110FL of the vehicle 100.

### Second Embodiment

Hereinafter, a second embodiment of the automatic charge control device according to the present disclosure will be described. Incidentally, the same configuration as that in the first embodiment in the second embodiment will not be described as appropriate.

In the automatic charging system 1 according to the second embodiment, when the charging service control server 4 receives the charging reservation from the user 3, a control is performed to lock the front and rear (all) doors 110FL and 110RL and windows 111FL and 111RL of the charging port 101 side of the vehicle 100. Then, in the automatic charging system 1 according to the second embodiment, after locking the front and rear (all) doors 110FL and 110RL and windows 111FL and 111RL of the charging port 101 side of the vehicle 100, automatically charging by the charging robot 20 starts.

Further, in the automatic charging system 1 according to the second embodiment, during the charging work by the charging robot 20, the presence or absence of contact with respect to the charging robot 20 is constantly monitored using the contact detection sensor. Further, in the automatic charging system 1 according to the second embodiment, a control is performed to continuously monitoring the presence or absence of contact with respect to the charging cable 32 using a load sensor.

In the automatic charging system 1 according to the second embodiment, the load sensor for detecting the load applied to the robot arm 22 of the charging robot 20 is provided on the robot arm 22. Then, during the charging operation by the charging robot 20, when the load of the preset threshold value or more is detected by the load sensor, the charging cable 12 performs control to determine that it has contacted something. When it is determined that the charging cable 12 is in contact with something (when the load of the threshold value or more is detected by the load sensor), the charging work is stopped, and when the load of the threshold value or more is no longer detected by the load sensor, the charging work is resumed.

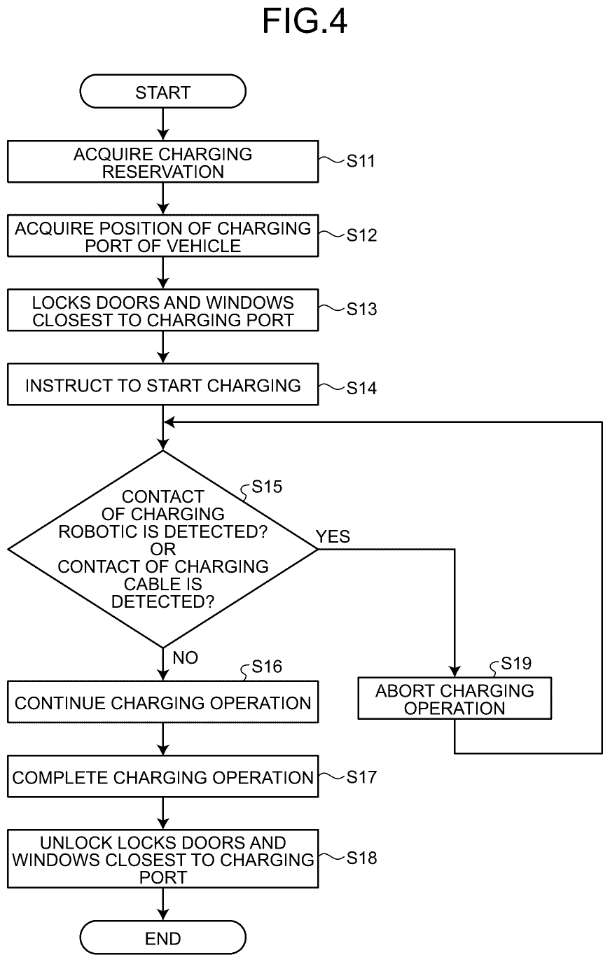

FIG. 4 is a flowchart illustrating an example of an automatic charging control according to the second embodiment.

First, in step S11, the charging service control server 4 acquires the charging reservation from the user 3. Next, in step S12, the charging service control server 4 acquires the position of the charging port 101 of the vehicle 100 to be charged from the vehicle information server 5. Next, in step S13, the charging service control server 4 locks the front and rear (all) doors 110FL and 110RL and windows 111FL and 111RL of the charging port 101 side of the vehicle 100 to the vehicle 100 via the vehicle information server 5. Next, in step S14, the charging service control server 4 instructs the automatic charging device 2 to start charging.

Next, in step S15, it is determined whether the contact of the charging robot 20 is detected or the contact of the charging cable 32 is detected. When the contact of the charging robot 20, or the contact of the charging cable 32 is determined (Yes in step S15), the process proceeds to step S19. In step S19, the charging operation by the charging robot 20 is aborted. Thereafter, the process proceeds to step S15.

On the other hand, in step S15, if the contact of the charging robot 20, nor the contact of the charging cable 32 is detected (No in step S15), the process proceeds to step S16. In step S16, the charging operation is continuously performed by the charging robot 20. Next, in step S17, when the electric power is supplied to the battery of the vehicle 100 and the charging is completed, the charging operation by the charging robot 20 is ended. Next, in step S18, the charging service control server 4 unlocks the front and rear (all) doors 110FL and 110RL and windows 111FL and 111RL of the charging port 101 side of the vehicle 100 via the vehicle information server 5. Hereafter, the charging service control server 4 ends a series of automatic charging control.

In the automatic charging system 1 according to the second embodiment, it performs control to lock the front and rear (all) doors 110FL and 110RL and windows 111FL and 111RL of the charging port 101 side of the vehicle 100. As a result, it is possible to prevent the occupant from getting on and off from the front and rear (all) doors 110FL and 110RL of the vehicle 100 on the charging port 101 side. Further, it is possible to occupants in the vehicle 100 to suppress the out of the hand or the like from the front and rear (all) windows 111FL and 111RL of the charging port 101 side. Thus, in the automatic charging system 1 according to the second embodiment, during the charging operation by the charging robot 20, it is possible to suppress the contact between the occupant with the charging robot 20 and the charging cable 32,

### Third Embodiment

Hereinafter, a third embodiment of the automatic charge control device according to the present disclosure will be described. Incidentally, the same configurations as those in the first embodiment in the third embodiment will not be described as appropriate.

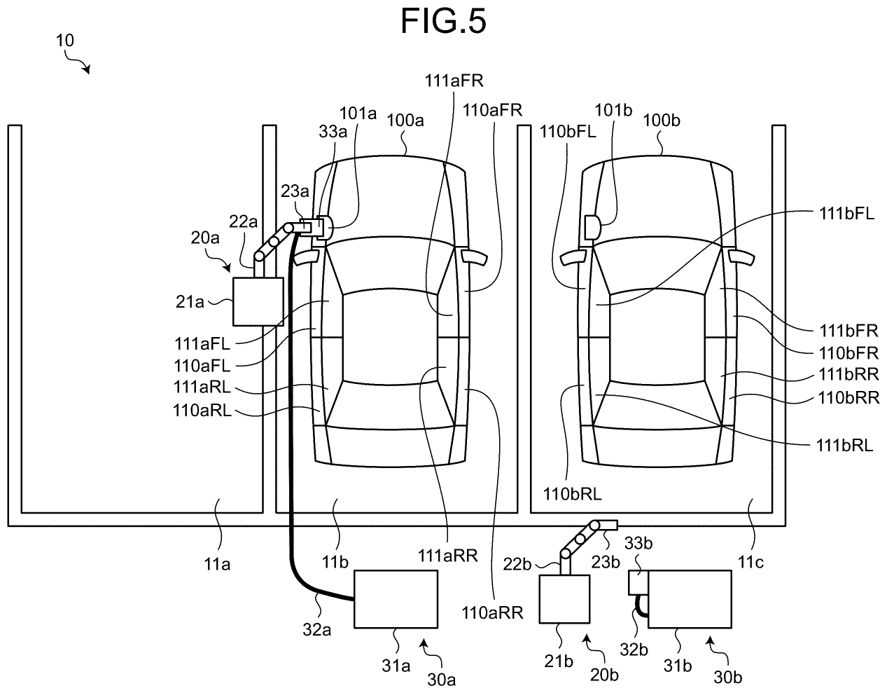

FIG. 5 is a diagram illustrating a parking lot 10 to which the automatic charging system 1 according to the third embodiment is applied.

In the automatic charging system 1 according to the third embodiment, as illustrated in FIG. 5, the vehicle 100a is parked in the parking space 11b, and the vehicle 100b is parked in the parking space 11c. The Vehicle 100a is provided with a charging port 101a, front and rear and left and right doors 110aFL, 110aFR, 110aRL, and 110aRR, and front and rear and left and right windows 111aFL, 111aFR, 111aRL, and 111aRR and the like. The vehicle 100b is provided with a charging port 101b, front and rear and left and right doors 110bFL, 110bFR, 110bRL, and 110bRR, and front and rear and left and right windows 111bFL, 111bFR, 111bRL, and 111bRR and the like. Since the configurations of the vehicles 100a and 100b is the same as those of the vehicle 100 according to the first embodiment, a detailed description thereof will be omitted.

In the automatic charging system 1 according to the third embodiment, for the vehicle 100a parked in the parking space 11b, automatic charging is performed by the charging robot 20a and the charger 30a constituting the automatic charging device. Further, for the vehicle 100b parked in the parking space 11c, automatic charging is performed by the charging robot 20b and the charger 30b constituting the automatic charging device. The recharging robots 20a and 20b include robot bodies 21a and 21b, robot arms 22a and 22b and robot hands 23a and 23b, respectively. The chargers 30a and 30b include charger bodies 31a and 31b, charging cables 32a and 32b and charging connectors 33a and 33b, respectively. Further, the configurations of the charging robots 20a and 20b and the chargers 30a and 30b are the same as the configuration of the charging robot 20 and the charger 30 of the first embodiment, respectively, a detailed description thereof will be omitted.

In the automatic charging system 1 according to the third embodiment, upon receiving an instruction of automatic charging starting from the user 3 of the vehicle 100a parked in the parking space 11b, the position of the charging port 101a of the vehicle 100a is obtained. Then, the automatic charging system 1 according to the third embodiment executes the control for locking the front and rear doors 110aFL and 110aRL and windows 111aFL and 111aRL of the charging port 101a in the vehicle 100a.

Further, in the automatic charging system 1 according to the third embodiment, in the parking space 11c opposite to the charging port 101a of the vehicle 100a parked in the parking space 11b, whether another vehicle 100 is parked (presence or absence of other vehicle 100) is determined. Then, in the parking space 11c on the side opposite to the charging port 101a of the vehicle 100a, when it is determined that the other vehicle 100 (vehicle 100b in FIG. 5) is parked (there is another vehicle 100), a control is performed to lock all the doors 110aFR and 110aRR and the windows 111aFR and 111aRR on the opposite side of the charging port 101a in the vehicle 100a. On the other hand, in the parking space 11c on the opposite side of the charging port 101a of the vehicle 100a, when it is determined that the other vehicle 100 is not parked (there is no other vehicle 100), no control is performed to lock the doors 110aFR and 110aRR and the windows 111aFR and 111aRR on the opposite side of all (front and rear) of the charging port 101a in the vehicle 100a.

Further, in the automatic charging system 1 according to the third embodiment, similar to the automatic charging system 1 according to the second embodiment, during the charging work by the charging robot 20, the presence or absence of contact with respect to the charging robot 20 is constantly monitored using the contact detection sensor. Further, in the automatic charging system 1 according to the third embodiment, the control for continuously monitoring the presence or absence of contact with respect to the charging cable 32 is performed using the load sensor.

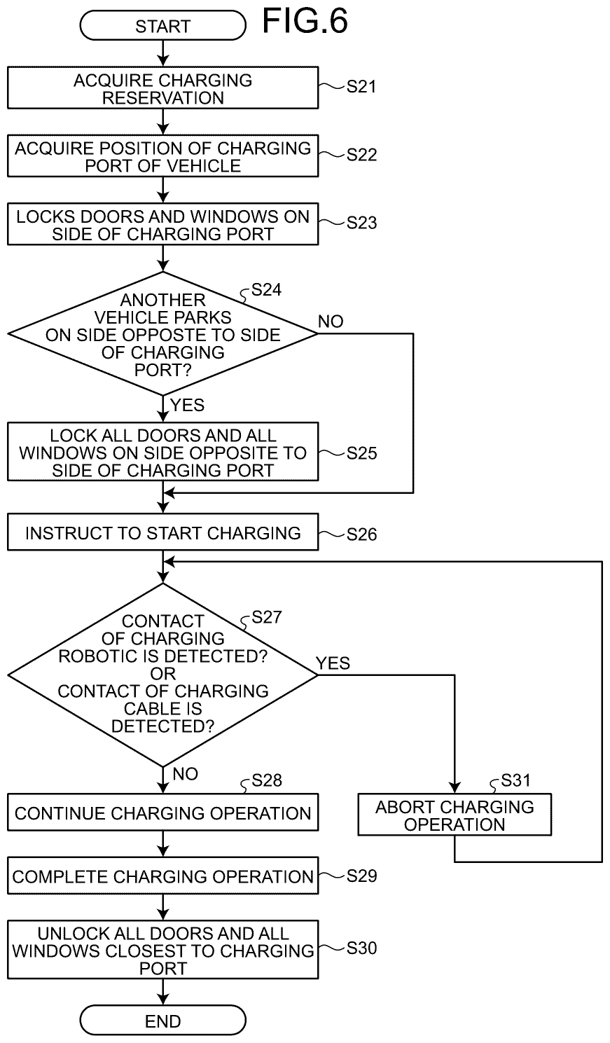

FIG. 6 is a flowchart illustrating an example of the automatic charging control according to the third embodiment.

First, in step S21, the charging service control server 4 acquires the charging reservation from the user 3. Next, in step S22, the charging service control server 4 acquires the position of the charging port 101a of the vehicle 100a to be charged from the vehicle information server 5. Next, in step S23, the charging service control server 4 locks the front and rear (all) doors 110aFL and 110aRL and the windows 111aFL and 111aRL of the charging port 101a side of the vehicle 100a to the vehicle 100a through the vehicle information server 5. Next, in step S24, based on the detected result of the parking lot monitoring system 6, the charging service control server 4 determines whether or not the other vehicle is parked on the opposite side to the charging port 101a of the vehicle 100a. If it is determined that the other vehicle on the opposite side of the charging port 101a of the vehicle 100a is not parked (No in step S24), the process proceeds to step S26. On the other hand, when it is determined that the other vehicle (vehicle 100b) is parked on the opposite side to the charging port 101a of the vehicle 100a (Yes in step S24), the process proceeds to step S25. In step S25, the front and rear (all) doors 110aFR and 110aRR and the window 111aFR and 111aRR on the other side of the vehicle 100a from the charging port 101a are locked. Next, in step S26, the charging service control server 4 instructs the auto charging device composed of the charging robotic 20a and the charger 30a to start charging.

Next, in step S27, it is determined whether the contact of the charging robotic 20a is detected or the contact of the charging cabling 32a is detected. If the contact of the charging robotic 20a or the contact of the charging cabling 32a is detected (Yes in step S27), the process proceeds to step S31. In step S31, the charging operation by the charging robotic 20a is aborted. Thereafter, the process proceeds to step S27.

On the other hand, in step S27, if the contact of the charging robotic 20a and the contact of the charging cabling 32a is not detected (No in step S27), the process proceeds to step S28. In step S28, the charging operation by the charging robotic 20a is continuously performed. Next, in step S29, when the electric power is supplied to the battery of the vehicle 100a and the charging is completed, the charging operation by the charging robotic 20a is terminated. Next, in step S30, the charging service control server 4 unlocks the front and rear (all) doors 110aFL and 110aRL and the windows 111aFL and 111aRL of the charging port 101a in the vehicle 100a to the vehicle 100 via the vehicle information server 5. Incidentally, in step S25, if the front and rear (all) doors 110aFL and 110aRL and the windows 111aFL and 111aRL of the side opposite the charging port 101a of the vehicle 100a are locked, the doors 110aFL and 110aRL and the window 111aFL and 111aRL are unlocked. Thereafter, the charging service control server 4 ends a series of automatic charging control.

In the automatic charging control device according to the third embodiment, when the vehicle 100b is parked on the side opposite to the charging port 101a of the vehicle 100a and automatic charging by the charging robot 20a of the e vehicle 100a is performed, and the vehicle 100b performs charging by another charging robot 20b, it is possible to suppress the getting on and off of persons via the doors 110aFR and 110aRR of the side close to the charging robot 20b. In addition, it is possible to prevent an occupant in the car 100a from releasing his or her hand from the windows 111aFR and 111aRR.

In the automatic charging system 1 according to the third embodiment, it is possible to suppress the contact between the occupant with the charging robots 20a and 20b and the charging cable 32a and 32b of the vehicle 100a during the charging operation of the vehicle 100a by the charging robot 20a.

In the automatic charging system 1 according to the third embodiment, when performing the charging operation of the vehicle 100a by the charging robot 20a, it may be controlled to lock only the door 110aFL and window 111aFL closest to the charging port 101a of the vehicle 100a.

### Forth Embodiment

Hereinafter, a fourth embodiment of the automatic charge control device according to the present disclosure will be described. Incidentally, the same configurations as those in the first embodiment in the fourth embodiment will not be described as appropriate.

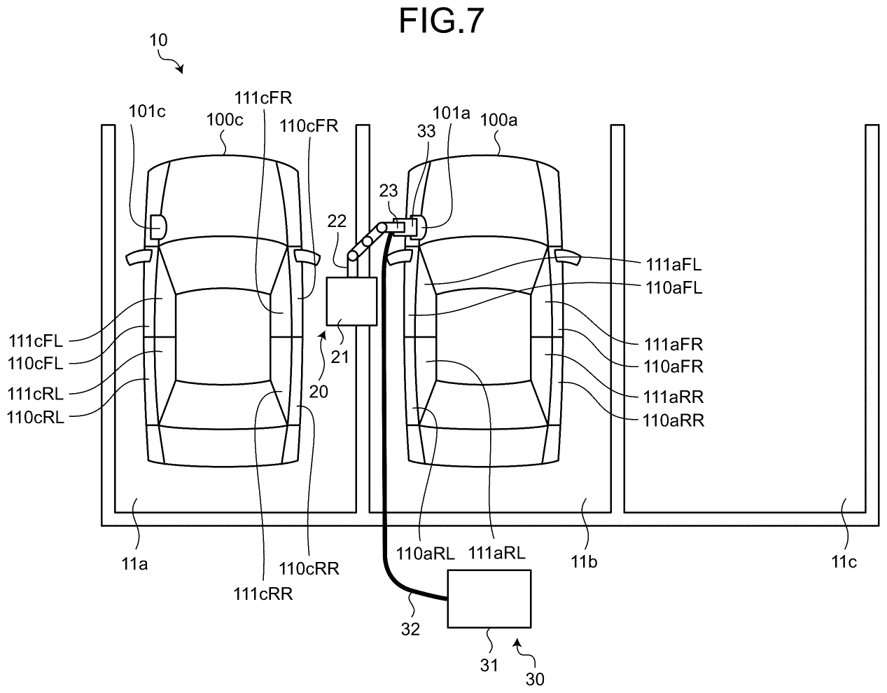

FIG. 7 is a diagram illustrating a parking lot 10 to which the automatic charging system 1 according to the fourth embodiment is applied.

In the auto-charging system 1 according to the fourth embodiment, as illustrated in FIG. 7, the vehicle 100a is parked in the parking space 11b, and the vehicle 100c is parked in the parking space 11a. The vehicle 100a is provided with a charging port 101a, the front and rear and left and right doors 110aFL, 110aFR, 110aRL, and 110aRR, and front and rear and left and right windows 111aFL, 111aFR, 111aRL, and 111aRR and the like. The vehicle 100c is provided with a charging port 101c, front and rear and left and right doors 110cFL, 110cFR, 110CRL, and 110cRR, and front and rear and left and right windows 111cFL, 111cFR, 111cRL, and 111cRR and the like. Since the configurations of the vehicles 100a and 100c are the same as those of the vehicle 100 according to the first embodiment, a detailed description thereof will be omitted.

In the automatic charging system 1 according to the fourth embodiment, upon receiving an instruction of automatic charging starting from the user 3 of the vehicle 100a parked in the parking space 11b, the position of the charging port 101a of the vehicle 100a is obtained. Then, the automatic charging system 1 according to the fourth embodiment executes the control for locking the doors 110aFL and 110aRL and the window 111aFL and 111aRL of all (front and rear) of the charging port 101a side of the vehicle 100a.

Further, in the automatic charging system 1 according to the fourth embodiment, it is determined whether another vehicle 100 is parked in the parking space 11a of the charging port 101a of the vehicle 100a parked in the parking space 11b (presence or absence of other vehicle 100). Then, when it is determined that the other vehicle 100 (vehicle 100c in FIG. 7) is parked (there is another vehicle 100) the parking space 11a on the charging port 101a side of the vehicle 100a, a control is performed to lock all (front and rear) of the doors 110cFR and 110cRR and the windows 111cFR and 111cRR on the charging port 101a side of the vehicle 100a in the other vehicle (on the side facing the charging port 101a side of the vehicle 100a in the other vehicle 100).

Further, in the automatic charging system 1 according to the fourth embodiment, similar to the automatic charging system 1 according to the second embodiment, during the charging work by the charging robot 20, the presence or absence of contact with respect to the charging robot 20 is constantly monitored using the contact detection sensor. Further, in the automatic charging system 1 according to the fourth embodiment, the control continuously monitoring the presence or absence of contact with respect to the charging cable 32 is performed using a load sensor.

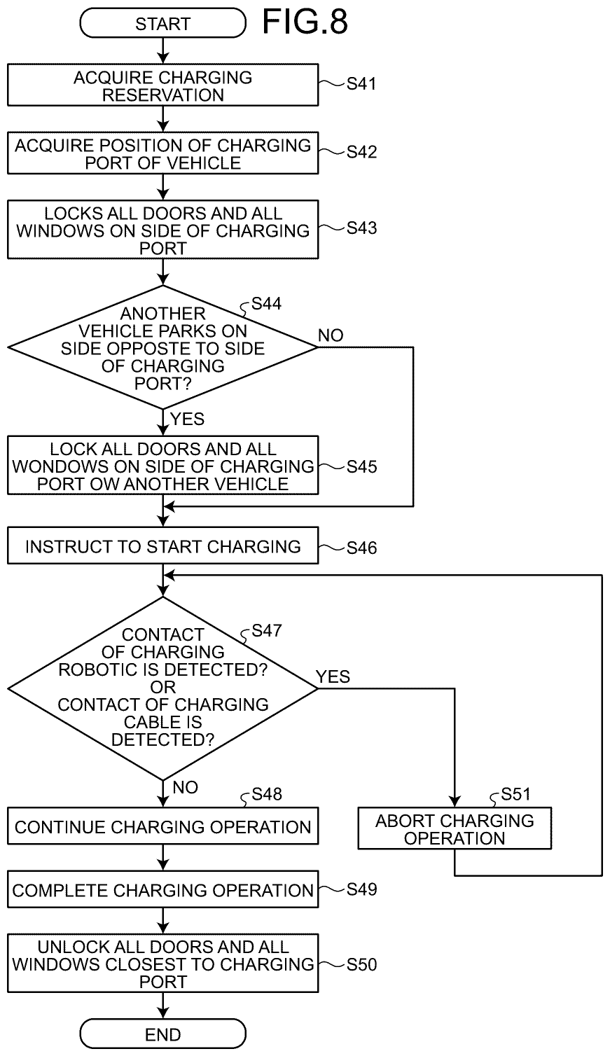

FIG. 8 is a flowchart illustrating an example of the automatic charging control according to the fourth embodiment.

First, in step S41, the charging service control server 4 acquires the charging reservation from the user 3. Next, in step S42, the charging service control server 4 acquires the position of the charging port 101a of the vehicle 100a to be charged from the vehicle information server 5. Next, in step S43, the charging service control server 4 locks the front and rear (all) doors 110aFL and 110aRL and the windows 111aFL and 111aRL of the charging port 101a in the vehicle 100a to the vehicle 100 via the vehicle information server 5. Next, in step S44, based on the detected result of the parking lot monitoring system 6, the charging service control server 4 determines whether the other vehicle is parked on the charging port 101a of the vehicle 100a. If it is determined that the other vehicle is no parked on the charging port 101a of the vehicle 100a (No at step S44), the process proceeds to step S46. On the other hand, when it is determined that the other vehicle (vehicle 100c) is parked on the charging port 101a of the vehicle 100a (Yes at step S44), the process proceeds to step S45. In step S45, the front and rear (all) doors 110cFR and 110cRR and the windows 111cFR and 111cRR of the charging port 101a of the vehicle 100a in another vehicle (vehicle 100c) are locked. Next, in step S46, the charging service control server 4 instructs the automatic charging device 2 to start charging.

Next, in step S47, it is determined whether the contact of the charging robot 20 is detected or the contact of the charging cable 32 is detected. Detecting the contact of the charging robot 20, or when it is determined that the contact of the charging cable 32 (Yes in step S47), the process proceeds to step S51. In step S51, the charging operation by the charging robot 20 is aborted. Thereafter, the process proceeds to step S47.

On the other hand, in step S47, if the contact of the charging robot 20 and the contact of the charging cable 32 are not detected (No in step S47), the process proceeds to step S48. In step S48, the charging operation is continuously performed by the charging robot 20. Next, in step S49, when the electric power is supplied to the battery of the vehicle 100a and the charging is completed, the charging operation by the charging robot 20 ends. Next, in step S50, the front and rear (all) doors 110aFL and 110aRL and the window 111aFL and 111aRL of the charging port 101a in the vehicle 100a are unlocked. Incidentally, in step S45, if the front and rear (all) doors 110cFL and 110CRL and the window 111cFL and 111cRL of the charging port 101a of the vehicle 100a in another vehicle (vehicle 100c) are unlocked, those doors 110cFL and 110cRL and the windows 111cFL and 111cRL are also unlocked. Thereafter, the charging service control server 4 ends a series of automatic charging control.

In the automatic charging system 1 according to the fourth embodiment, the control for locking the doors 110aFL and 110aRL and the windows 111aFL and 111aRL of all (front and rear) of the charging port 101a side of the vehicle 100a is performed. Thus, it is possible to prevent an occupant from being getting on and off the vehicle from the front and rear (all) of the doors 110aFL and 110aRL of the charging port 101a in the vehicle 100a. In addition, it is possible to prevent an occupant in the vehicle 100a from releasing the hand or the like from the front and rear (all) windows 111aFL and 111aRL of the charging port 101a. Furthermore, in the automatic charging system 1 according to the fourth embodiment, the control for locking the front and rear (all) doors 110cFL and 110cRL and the windows 111cFL and 111cRL of the charging port 101a of the vehicle 100a in the vehicle 100c is performed. Thus, it is possible to suppress the passenger getting on and off from the doors 110aFR and 110aRR on the charging port 101a of the vehicle 100a in the vehicle 100c. Further, it is possible to prevent the occupant in the vehicle 100c from releasing the hand or the like from the front and rear (all) windows 111cFR and 111cRR on the charging port 101a of the vehicle 101a in the vehicle 101c. Therefore, in the automatic charging system 1 according to the fourth embodiment, during the charging operation of the vehicle 100a by the charging robot 20, it is possible to suppress the contact between the occupant of the vehicles 100a and 100c with the charging robot 20 and the charging cable 32.

In the automatic charging system 1 according to the fourth embodiment, when performing the charging operation of the vehicle 100a by the charging robot 20a, it may be controlled to lock only the door 110aFL and the window 111aFL closest to the charging port 101a of the vehicle 100a. Further, in the automatic charging system 1 according to the fourth embodiment, when performing the charging operation of the vehicle 100a by the charging robot 20a, the control may be performed of locking only the closest door 110cFR and the window 111cFR to the charging port 101a of the vehicle 100a in the vehicle 100c.

In the automatic charging system according to the present disclosure, during the charging operation by the charging robot, an effect that it is possible to suppress the contact between the occupant and the charging robot of the vehicle is achieved.

According to the present disclosure, during the charging work by the charging robot, it is possible to prevent the getting on and off of the occupant from the door or window getting in and out from the door closest to the charging port in the vehicle and the release of the hand or the like of the occupant from the window, and thus, it is possible to suppress the contact between the occupant of the vehicle and the charging robot.

According to the present disclosure, it is possible to prevent the contact between the occupant of the vehicle and the charging robot of the other vehicle.

According to the present disclosure, during automatic charging of the vehicle by the charging robot, it is possible to prevent the contact between the occupant of the other vehicle and the charging robot.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An automatic charging system comprising:
a vehicle driven by power supplied from a power storage device;
a charger equipped with a charging cable having a charging connector;
a charging robot, which is autonomously movable, equipped with a robot arm, the robot arm being configured to automatically grasp the charging connector, and insert and remove the charging connector into and from a charging port of the vehicle parked in a parking space, so that the charging connector is inserted into the charging port and power is supplied from the charger and is charged to the power storage device; and
a control device configured to cause the vehicle to lock a door and a window, each of which is a closest to the charging port, during at least a charging operation, in which the charging robot receives an instruction to start automatic charging, starts autonomous moving from a predetermined stand-by position, completes charging power to the power storage device, and returns to the predetermined stand-by position.

2. An automatic charging system comprising:
a vehicle driven by power supplied from a power storage device;
a charger equipped with a charging cable having a charging connector;
a charging robot, which is autonomously movable, equipped with a robot arm, the robot arm being configured to automatically grasp the charging connector, and insert and remove the charging connector into and from a charging port of the vehicle parked in a parking space, so that the charging connector is inserted into the charging port and power is supplied from the charger and is charged to the power storage device; and
a control device configured to cause the vehicle to lock all doors and all windows, which are on a side of the charging port of the vehicle, during at least a charging operation, in which the charging robot receives an instruction to start automatic charging, starts autonomous moving from a predetermined stand-by position, completes charging power to the power storage device, and returns to the predetermined stand-by position.

3. The automatic charging system according to claim 1, further comprising a vehicle detection device which is configured to detect whether there is another vehicle in a position on a side opposite to the side of the charging port of the vehicle, wherein, when the another vehicle is detected on a basis of the detection result of the vehicle detection device, the control device is configured to cause the vehicle to lock all doors and all windows, which are on a side opposite to the side of the charging port of the vehicle, during at least the charging operation.

4. The automatic charging system according to claim 2, further comprising a vehicle detection device which is configured to detect whether there is another vehicle in a position on a side opposite to the side of the charging port of the vehicle, wherein, when the another vehicle is detected on a basis of the detection result of the vehicle detection device, the control device is configured to cause the vehicle to lock all doors and all windows, which are on a side opposite to the side of the charging port of the vehicle, during at least the charging operation.

5. The automatic charging system according to claim 1, further comprising a vehicle detection device which is configured to detect whether there is another vehicle in a position facing the charging port of the vehicle each other, wherein, when the another vehicle is detected on a basis of the detection result, the control device is configured to cause the another vehicle to lock all doors and all windows, which are on a side facing the charging port of the vehicle, during at least the charging operation.

6. The automatic charging system according to claim 2, further comprising a vehicle detection device which is configured to detect whether there is another vehicle in a position facing the charging port of the vehicle each other, wherein, when the another vehicle is detected on a basis of the detection result, the control device is configured to cause the another vehicle to lock all doors and all windows, which are on a side facing the charging port of the vehicle, during at least the charging operation.
